(19) United States
(12) Patent Application Publication
(10) Pub. No.: US 2016/0110530 A1
(43) Pub. Date: Apr. 21, 2016

(54) METHOD AND A SYSTEM FOR AUTHENTICATING A USER IN TERMS OF A CLOUD BASED ACCESS CONTROL SYSTEM

(71) Applicant: iPulse Systems (Pty) Limited, Chloorkop (ZA)

(72) Inventors: Gary Michael Chalmers, Johannesburg (ZA); Louis Francois van Loggerenberg, Johannesburg (ZA); Thomas Snyman, Johannesburg (ZA); Dean Bernard Zwarts, Johannesburg (ZA); Donovan Sargeant, Johannesburg (ZA)

(21) Appl. No.: 14/725,198

(22) Filed: May 29, 2015

(30) Foreign Application Priority Data
Oct. 15, 2014 (ZA) 2014/07453

(51) Int. Cl. G06F 21/32; H04L 29/06; G06F 17/30; G06K 9/00

(52) U.S. Cl. CPC G06F 21/32; G06K 9/00087; G06K 9/00013; G06K 9/00093; H04L 63/0853; G06F 17/30

(57) ABSTRACT

Aspects extend to methods and systems for authenticating a user in terms of a cloud based access control system.

### CROSS-REFERENCE TO RELATED APPLICATIONS

This application claims priority to South African Application No. ZA2014/07453, filed Oct. 15, 2014 and entitled “A METHOD AND A SYSTEM FOR AUTHENTICATING A USER IN TERMS OF A CLOUD BASED ACCESS CONTROL SYSTEM”.

### FIELD OF THE INVENTION

This invention relates to a method of, and a system for authenticating a user in terms of a cloud based access control system.

### BACKGROUND TO THE INVENTION

Conventionally, in the fields of physical security and information security, access control is the selective restriction of access to a place or other resource. The act of accessing may mean consuming, entering, or using. Permission to access a resource is called authorization.

Locks and login credentials are two analogous mechanisms of access control.

Access control in the strict sense (physically controlling access itself) is a system of checking authorized presence, see e.g. Ticket controller (transportation). A variant is exit control, e.g. of a shop (checkout) or a country.

The term access control refers to the practice of restricting entrance to a property, a building, or a room to authorized persons. Physical access control can be achieved by a human (a guard, bouncer, or receptionist), through mechanical means such as locks and keys, or through technological means such as access control systems. Within these environments, physical key management may also be employed as a means of further managing and monitoring access to mechanically keyed areas or access to certain small assets.

Physical access control is a matter of who, where, and when. An access control system determines who is allowed to enter or exit, where they are allowed to exit or enter, and when they are allowed to enter or exit. Historically, this was partially accomplished through keys and locks. When a door is locked, only someone with a key can enter through the door, depending on how the lock is configured. Mechanical locks and keys do not allow restriction of the key holder to specific times or dates. Mechanical locks and keys do not provide records of the key used on any specific door, and the keys can be easily copied or transferred to an unauthorized person. When a mechanical key is lost or the key holder is no longer authorized to use the protected area, the locks must be re-keyed.

In terms of conventional functioning, electronic access control uses computers solve the limitations of mechanical locks and keys. A wide range of credentials can be used to replace mechanical keys. The electronic access control system grants access based on the credential presented. When access is granted, the door is unlocked for a predetermined time and the transaction is recorded. When access is refused, the door remains locked and the attempted access is recorded. The system will also monitor the door and alarm if the door is forced open or held open too long after being unlocked.

Biometric access control systems can be used to allow predetermined authorized users to gain access to, for example a door, by way of an authentication process in terms of which the identity of a user is verified and he/she is allowed access through the door based on predetermined access control criteria.

However, in the industry at present, an access control system does not exist which addresses concerns regarding the real-time updating of information related to authorized users. This is particularly true in instances where the biometric access control device is a stand-alone device and does not receive updates from a centralized server or database.

### OBJECT OF THE INVENTION

The object of this invention is to provide a method of, and a system for authenticating a user in terms of a cloud based access control system which addresses some of the above concerns and provides the additional functionality included above, this additional functionality being lacking in a conventional access control mechanism.

### SUMMARY OF THE INVENTION

According to a first aspect of the invention, there is provided a method of authenticating a user in terms of a cloud based access control system, said method comprising one or more of the following steps, in use:
populate a database with predetermined fingerprint data from a biometric sensor;
associate said predetermined fingerprint data with a database comprising information related to one or more authorized users in terms of said access control system;
store said associated fingerprint data with information related to access permissions of one or more authorized users in a cloud;
load data associated with authorization permissions of said individual user to said access card;
swipe said access card at said access control system;
read a fingerprint of said user at said access control system;
compare fingerprint data of said user obtained from the cloud to the fingerprint data retrieved from reading a fingerprint of said user at said access control system; and
grant or deny access to said user based on a successful comparison between said data obtained from the cloud and one or more access permission(s) of said user, as retrieved from said access card.

In an embodiment of the invention, said method comprises the initial step of:
scanning a fingerprint of a user and storing data related to said fingerprint in said database.

According to a second aspect of the invention, there is provided a system for authenticating a user in terms of a cloud based access control system, said system comprising the following:
a back-end system comprising a database of one or more access permissions of one or more users and a database of fingerprint data of one or more users;
a database of fingerprint data associated with one or more access permissions of one or more authorized users;
a centralized storage system within which the fingerprint data of authorized users are stored;
one or more access cards comprising one or more access control permissions of an individual user; and
an access control system, operable to control access to a door, said access control system comprising a fingerprint reader operable to read a fingerprint of a user and to look-up said read fingerprint data in the cloud and to obtain information related to one or more access permission of said user so as to determine whether said user is to be granted or denied access to a location controlled by said access control system.

In an embodiment of the invention, said predetermined fingerprint data comprises a number of extracted features or minutia of said user. In this embodiment of the invention, said predetermined fingerprint data is provided in the form of a digitally stored biometric template of a finger of said user.

In an embodiment of the invention, said system further comprises a fingerprint scanning device operable to detect and store fingerprint data related to a finger of a user using said device.

In an embodiment of the invention, said centralized storage system is provided in the form of a cloud computing environment.

### BRIEF DESCRIPTION OF THE DRAWINGS

These and other features of this invention will become apparent from the following description of one example described with reference to the accompanying drawings in which:

FIG. 1 shows a system for authenticating a user in terms of a cloud based access control system, in accordance with embodiments of the invention; and

FIG. 2 shows a method of authenticating a user in terms of a cloud based access control system through use of the system of FIG. 1, in accordance with embodiments of the invention.

### DETAILED DESCRIPTION

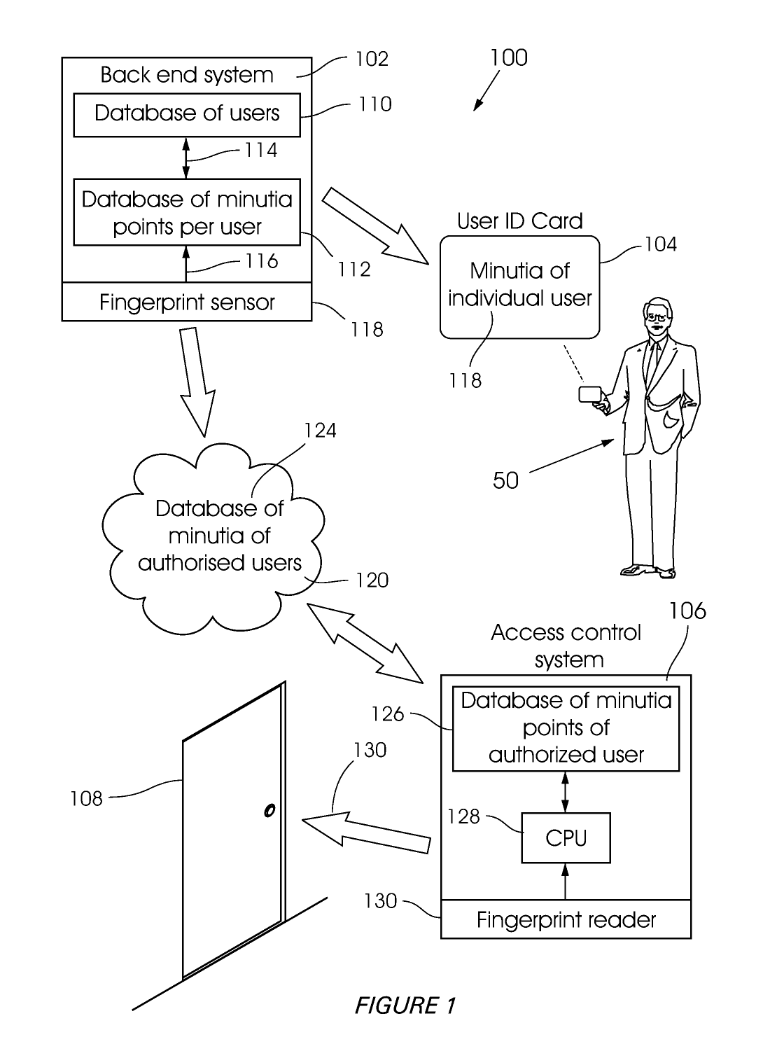

With reference to FIG. 1, a system for authenticating a user in terms of a cloud based access control system, is generally described with reference to numeral 100.

The system 100 comprises a back-end system 102, a user identification (ID) card 104, an access control system 106, a cloud storage system 120 all of these components governing the access of a user 50 to a door 108.

The back-end system 102 comprises a first database of authorized users 110 including the access permissions of individual users, a second database of fingerprint data, including the minutia points 112 of user(s) and a fingerprint sensor 118 operable to obtain the fingerprint data from the user(s). In use, the first database 110 and the second database 112 are associated with one another and the access permissions of individual users can be associated with the minutia points of that user after having been obtained by way of the fingerprint sensor 118.

The user ID card 104 comprises the access permissions of an individual user 50 in so far as this has been associated with the minutia points 118 of the user 50, on the card 104.

The access control system 106 comprises a third database 120 of minutia points of each authorized user including the access permissions of that user. The access control system further includes a fingerprint reader 128 operable to obtain a real-time scan of a fingerprint of a user 50. The access control system 106 further comprises a central processing unit (CPU) 122 operable to compare the (previously obtained) stored minutia data of a user with the fingerprint data obtained from the user in real-time. This is due to the fact that the CPU 122 feeds off information obtained (124) from the third database 120 and similarly feeds off information obtained (126) from the fingerprint reader 128 and then compares the two.

A centralized data storage system, in the form of the cloud 120, comprises a database of minutia points of authorized users 124.

In use, once the CPU 122 has determined that the real-time fingerprint data obtained from the reader 128 is the same as the stored fingerprint minutia of the user 50 as obtained from the cloud and that the user 50 has permission to access the door 108, by way of information in the third database 120, the access control system 106 will provide the user 50 with access to the door 108.

In accordance with example embodiments of the invention, physical access to the door 108 can be granted by way of an intelligent relay (or switch) which is positioned on the door 108 and which the access control system 106 then activates to allow the user 50 to pass through the door.

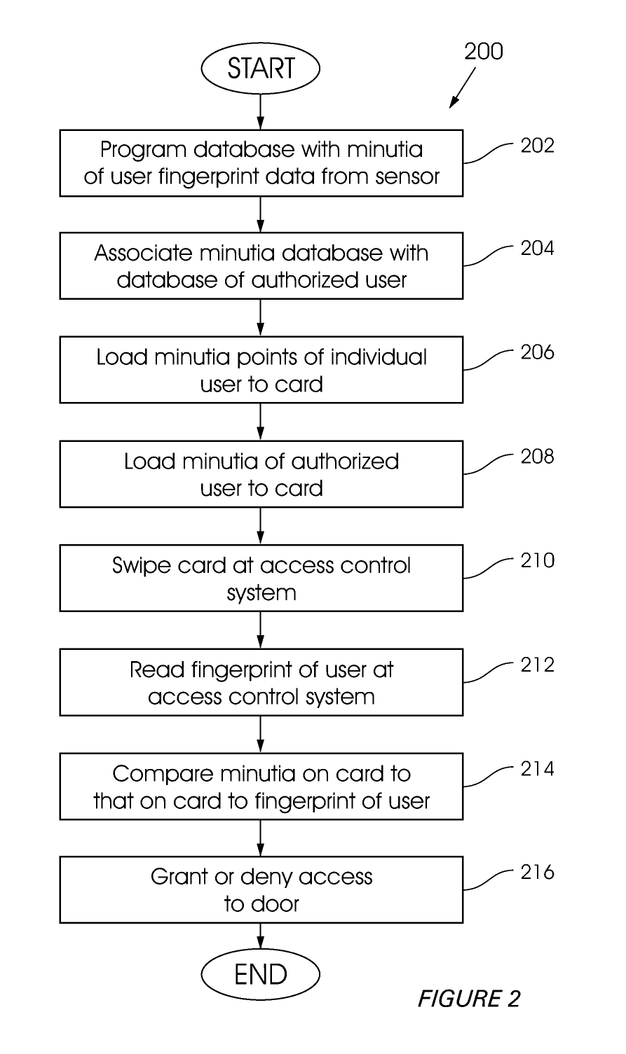

With reference to FIG. 2, a method of authenticating a user in terms of a cloud based access control system, is generally described with reference to numeral 200.

The method 200 comprises one or more of the following steps, in accordance with example embodiments of the invention.

At block 202, a database is programmed with the fingerprint data and minutia information of a user, in so far as these have been obtained by way of a fingerprint sensor.

At block 204, the minutia database including the fingerprint data of authorized users is associated with another database, including the access permissions of individual users. This information is then stored within a centralized computing environment, such as the cloud.

At block 206, the minutia data and access permissions of an individual user (owner) of the access ID card is loaded onto the card.

At block 208, the access ID card is swiped at an access control system and the minutia data and specific access permissions of the user is obtained from the cloud and from the card respectively.

At block 210, a fingerprint of a user is obtained in real-time at an access control system.

At block 212, the access control system compares the minutia on the card to the fingerprint data obtained from the sensor in real-time in order to verify the identity of the user.

At block 214, access to a door is either granted or denied in respect of a user based on the outcome of the above comparison and verification of the user and the specific access permissions of the individual user in question.

1. A method of authenticating a user in terms of a cloud based access control system, said method comprising:
populating a database with predetermined fingerprint data from a biometric sensor;
associating said predetermined fingerprint data with a database comprising information related to one or more authorized users in terms of said access control system;
storing said associated fingerprint data with information related to access permissions of one or more authorized users in a centralized data storage system;
loading data associated with authorization permissions of said individual user to said access card;
swiping said access card at said access control system;
reading a fingerprint of said user at said access control system;
comparing fingerprint data of said user obtained from the cloud to the fingerprint data retrieved from reading a fingerprint of said user at said access control system; and
determining access for said user based on a successful comparison between said data obtained from the cloud and one or more access permissions of said user, as retrieved from said access card.

2. The method of claim 1, wherein said method further comprises:
scanning a fingerprint of a user and storing data related to said fingerprint in said database.

3. A system for authenticating a user in terms of a cloud based access control system, said system comprising the following:
a back-end system comprising a database of one or more access permissions of one or more users and a database of fingerprint data of one or more users;
a database of fingerprint data associated with one or more access permissions of one or more authorized users;
a cloud within which the fingerprint data of authorized users are stored;
one or more access cards comprising one or more access control permissions of an individual user; and
an access control system, operable to control access to a door, said access control system comprising a fingerprint reader operable to read a fingerprint of a user and to look-up said read fingerprint data in the cloud and to obtain information related to one or more access permission of said user so as to determine whether said user is to be granted or denied access to a location controlled by said access control system.

4. The system of claim 3, wherein said predetermined fingerprint data comprises a number of extracted features or minutia of said user.

5. The system of claim 3, wherein said predetermined fingerprint data is provided in the form of a digitally stored biometric template of a finger of said user.

6. The system of claim 3, further comprising a fingerprint scanning device operable to detect and store fingerprint data related to a finger of a user using said device.

7. The method of claim 1 wherein said centralized storage system is provided in the form of a cloud computing environment.

8. (canceled)

9. (canceled)

10. The system of claim 4, wherein said predetermined fingerprint data is provided in the form of a digitally stored biometric template of a finger of said user.
